(19) United States
(12) Patent Application Publication
(10) Pub. No.: US 2026/0065398 A1
(43) Pub. Date: Mar. 5, 2026

(54) AI-POWERED SYSTEM FOR CREATING CUSTOMIZED SCHOOL IMPROVEMENT PLANS AND METHOD THEREOF

(71) Applicant: Kimberly Dion Lane, West Orange, NJ (US)

(72) Inventor: Kimberly Dion Lane, West Orange, NJ (US)

(21) Appl. No.: 18/821,144

(22) Filed: Aug. 30, 2024

Related U.S. Application Data
(60) Provisional application No. 63/516,521, filed on Jul. 30, 2023.

(51) Int. Cl. G06Q 50/20; G06F 9/54; G06F 16/93

(52) U.S. Cl. CPC G06Q 50/205; G06F 9/547; G06F 16/93

(57) ABSTRACT

The present disclosure relates to an artificial intelligence (AI)-powered computer-implemented system (100) for connecting school leaders with informative resources that are aligned with industry-specific educational standards. The system (100) comprising a user device (102). The system (100) also comprising a document filtering module (104) configured to analyses and filter documents based on relevance to the received user inputs. The system (100) also comprising an intent recognition module (106) configured to interpret the user inputs to identify the user's intent and specific requirements. The system (100) also comprising a cloud-based application programming interface (API) module (114) and a page ranking module (116). The system (100) also comprising an artificial intelligence-based processing assembly (118) further having a document searching module (120), a text extraction module (122), and a summarizer (124). The system (100) also comprising an implementation, tracking, and evaluation module (ITEM) (126) configured to enable the users to apply best practices by providing recommendations, tracking progress, and evaluating outcomes.

### CROSS-REFERENCE TO RELATED APPLICATIONS

This application claims priority to U.S. Provisional Ser. No. 63/516,521, filed on Jul. 30, 2023, and incorporated herein by reference.

### FIELD OF THE INVENTION

Embodiments of the present invention relate to a learning system and specifically relate to a computer-implemented system for providing on-demand professional development and technical assistance to school leaders and creating customized school improvement plans.

### DESCRIPTION OF THE RELATED ART

The educational technology industry has made remarkable strides in recent years, particularly in creating platforms that cater to the professional development of teachers and leadership development in students. Such platforms often focus on enhancing pedagogical skills, integrating technology into the classroom, and promoting student engagement.

The advent of artificial intelligence (AI) in the educational technology industry has brought about transformative changes, yet a significant gap remains in addressing the in-service training needs of school leaders, particularly in elementary and secondary education. While numerous online professional development tools exist for teachers and other educational practitioners, school leaders often find themselves navigating complex challenges with limited relevant resources.

There is a need to provide a learning solution that integrates an artificial intelligence (AI) approach with the “EdTech” for creating customized learning paths that are relevant and immediately applicable to individual needs, strengths, and areas for growth for each school leader. Another requirement is to facilitate on-demand resources, training modules, and expert advice, as per the requirement of the user.

There is also a need for solution that can provide data-driven actionable insights to the leaders by processing student performance metrics, staff evaluations, and feedback. Thus, there is a need for an AI integrated edtech solution that can fulfill the in-training needs of leaders.

Therefore, the present invention provides a system for creating customized school improvement plans for leaders.

### SUMMARY OF THE INVENTION

Embodiments of the present invention relate to an artificial intelligence (AI)-powered computer-implemented system for connecting school leaders with informative resources that are aligned with industry-specific educational standards. The system comprises a user device. The system also comprises a document filtering module operationally coupled to the user device and the document filtering module configured to analyze and filter documents based on relevance to the received user inputs. The system also comprising an intent recognition module operationally coupled to the document filtering module and the intent recognition module configured to interpret the user inputs to identify the user's intent and specific requirements. The intent recognition module further comprises a conversational language understanding (CLU) engine, a knowledge-based database, and a plurality of domain-specific algorithms. The intent recognition module further comprises a cloud-based application programming interface (API) module operationally coupled to the document filtering module and the cloud-based application programming interface (API) module configured to facilitate communication between the user device, document filtering module, intent recognition module, and external computing resources. The intent recognition module further comprises a page ranking module operationally coupled to the cloud-based application programming interface (API) module and the page ranking module configured to rank filtered documents based on the relevance to the identified user intent and requirements. The intent recognition module further comprises an artificial intelligence (AI)-based processing assembly operationally coupled to the cloud-based application programming interface (API) module and the user device and the artificial intelligence (AI)-based processing assembly further having a document searching module, a text extraction module, and a summarizer. The intent recognition module further comprises an implementation, tracking, and evaluation module (ITEM) integrated with the cloud-based application programming interface (API) module and the implementation, tracking, and evaluation module (ITEM) configured to enable the users to apply best practices in the school by providing recommendations for project management, tracking progress, and evaluating outcomes.

In accordance with an embodiment of the present invention, the documents analyzed and filtered by the document filtering module comprise school leadership standards, guidelines, and resources.

In accordance with an embodiment of the present invention, the artificial intelligence (AI)-based processing assembly is also integrated with a search and recommendation engine.

In accordance with an embodiment of the present invention, the conversational language understanding engine analyses the user query via natural language processing techniques.

In accordance with an embodiment of the present invention, the natural language processing techniques interpret the semantic meaning of user queries and extract key information required for generating the school improvement plan.

In accordance with an embodiment of the present invention, the knowledge-based database storing domain-specific information and resources.

In accordance with an embodiment of the present invention, the domain-specific algorithms are configured to analyze and process user inputs based on the identified domain.

In accordance with an embodiment of the present invention, the document searching module retrieves relevant documents from internal and external sources.

In accordance with an embodiment of the present invention, the text extraction module extracts key information and data from the retrieved documents.

In accordance with an embodiment of the present invention, the summarizer is an artificial intelligence-driven module that generates concise summaries of the extracted information.

In accordance with an embodiment of the present invention, the user device is configured to allow the user to generate user queries, and receiving user inputs related to school leadership strategies and improvement goals.

In accordance with an embodiment of the present invention, the implementation, tracking, and evaluation module (ITEM) is also configured to allow the user to input data related to school improvement projects, track the implementation progress, and monitor the progress of various school improvement initiatives and provides real-time updates to users.

In accordance with an embodiment of the present invention, the combined functioning of the implementation, tracking, and evaluation module (ITEM) and the artificial intelligence (AI)-based processing assembly is operable to allow the user to access instructional and school leadership-related documents, and summarize the documents and inform about the relevant school leadership standards.

In accordance with an embodiment of the present invention, the implementation, tracking, and evaluation module (ITEM) in combination with the artificial intelligence (AI)-based processing assembly evaluate the effectiveness of implemented strategies and integrates feedback for continuous improvement.

In accordance with an embodiment of the present invention, the system also includes a chatbot configured to answer the user queries related to school leadership strategies, improvement plans, and the use of the implementation, tracking, and evaluation module (ITEM).

In accordance with an embodiment of the present invention, the chatbot is also operable to respond to the user queries with relevant information and resources, and guide the user through the process of creating, implementing, and tracking school improvement plans generated by the ITEM the implementation, tracking, and evaluation module (ITEM).

Another embodiment of the present invention relates to a method for creating customized school improvement plans using an artificial intelligence-powered platform. The method includes receiving a user query seeking general or standards-aligned information on school leadership strategies. The method also includes posing the question in chat to receive artificial intelligence (AI)-)-powered answers and resources. The method also includes using an implementation, tracking, and evaluation module (ITEM) to create customized school improvement plans. The method also includes seeking for general or standards-aligned information on school leadership strategies via the user query. The user query is aimed at accessing and examining proprietary school leadership standards, state-specific school leadership standards and enter other school leadership standards for analysis. The method also includes using the implementation, tracking, and evaluation module (ITEM) to create customizable school improvement plans.

In accordance with an embodiment of the present invention, in response to the user queries is in the form of abstracts, related articles and links, and generated answers.

In accordance with an embodiment of the present invention, the method further comprises allowing the user to seek standards-aligned information on school leadership strategies. The method further comprises uploading school leadership documents by the user from the personal archives for analysis by the platform. The method further comprises summarizing the uploaded documents and presenting the summaries in full to the user for review. The method further comprises allowing the user to save or favorite the uploaded resources.

In accordance with an embodiment of the present invention, the method also includes aligning the search and recommendation results obtained from a search and recommendation engine with the school leadership standards.

### BRIEF DESCRIPTION OF THE DRAWINGS

So that the manner in which the above-recited features of the present invention is understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

The invention herein will be better understood from the following description with reference to the drawings, in which:

FIG. 1A illustrates a block diagram for an artificial intelligence (AI)-powered computer-implemented system for connecting school leaders with informative resources that are aligned with industry-specific educational standards, in accordance with an embodiment of the present invention;

FIG. 1B illustrates a functional block diagram for an artificial intelligence (AI)-powered computer-implemented system for creating customized school improvement plans based on Microsoft Azure, in accordance with an embodiment of the present invention;

FIG. 1C illustrates a snapshot of the exemplary high-level technology stack for the artificial intelligence (AI)-powered computer-implemented system for creating customized school improvement plans based on Microsoft Azure, in accordance with an embodiment of the present invention;

FIG. 2A illustrates a flowchart for a method for creating customized school improvement plans using an artificial intelligence-powered platform, in accordance with an embodiment of the present invention;

FIG. 2B illustrates a snapshot of the overreaching function of the method for creating customized school improvement plans using an artificial intelligence-powered platform, in accordance with an embodiment of the present invention;

FIG. 2C illustrates a snapshot of the exemplary use case of the method for creating customized school improvement plans using an artificial intelligence-powered platform, in accordance with an embodiment of the present invention;

FIG. 3 illustrates an operational flowchart for an operational flowchart of a process for educators seeking information and resources on school leadership, in accordance with an embodiment of the present invention;

FIG. 4 illustrates an operational flowchart of knowledge base building process for educators seeking information and resources on school leadership, in accordance with an embodiment of the present invention; and

FIG. 5 illustrates an operational flowchart of a process for user input processing for chat/resources, in accordance with an embodiment of the present invention.

It should be noted that the accompanying figure is intended to present illustrations of exemplary embodiments of the present disclosure. This figure is not intended to limit the scope of the present disclosure. It should also be noted that the accompanying figure is not necessarily drawn to scale.

### DETAILED DESCRIPTION OF THE INVENTION

In the following detailed description, numerous specific details are set forth in order to provide a thorough understanding of the embodiment of the invention as illustrative or exemplary embodiments of the invention. Specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well-known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

The conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

The following brief definition of terms shall apply throughout the present invention

The terms “determining”, “measuring”, “evaluating”, “assessing,” “assaying,” and “analyzing” can be used interchangeably herein to refer to any form of measurement, and include determining if an element is present or not. (e.g., detection). These terms can include both quantitative and/or qualitative determinations. Assessing may be relative or absolute.

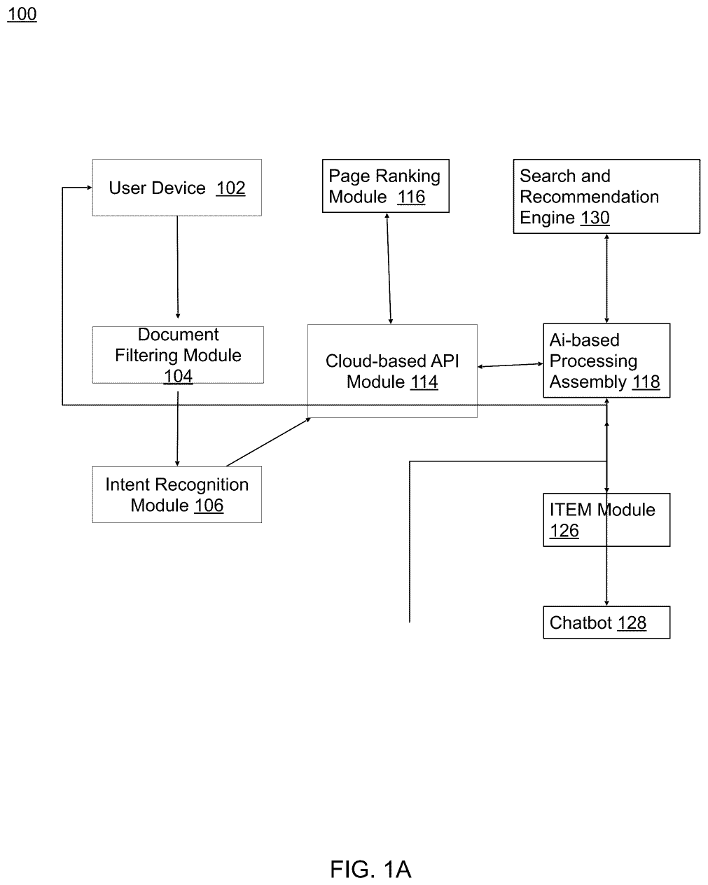

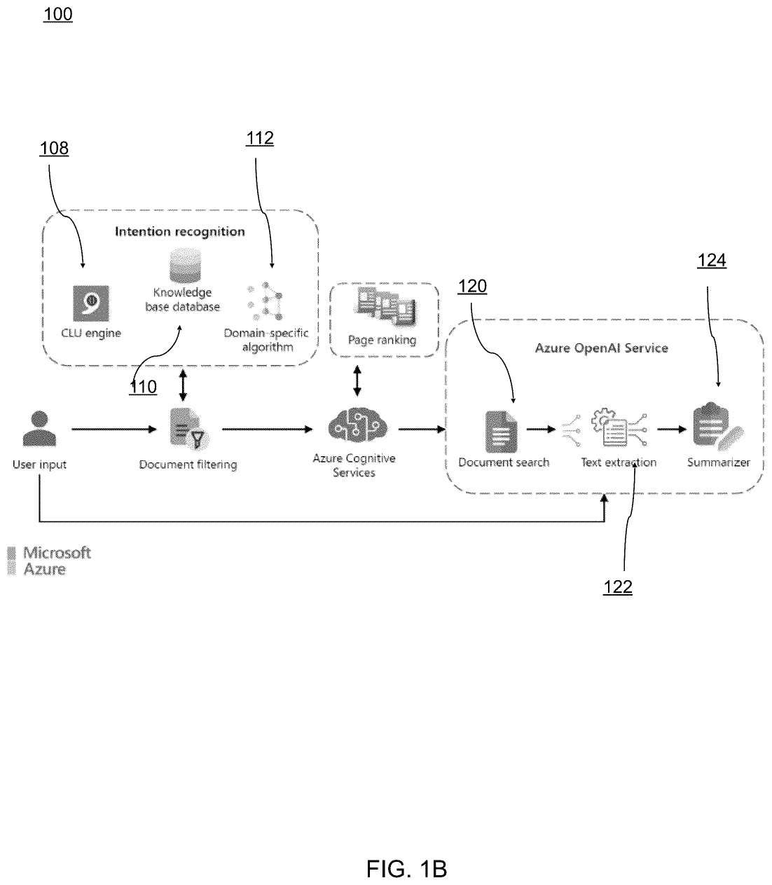

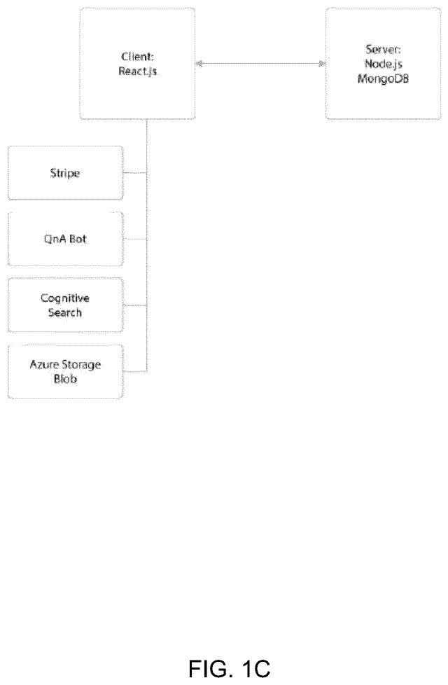

FIG. 1A illustrates a block diagram for an artificial intelligence (AI)-powered computer-implemented system for connecting school leaders with informative resources that are aligned with industry-specific educational standards, in accordance with an embodiment of the present invention.

The system 100 may comprise a user device 102, a document filtering module 104, an intent recognition module 106, a cloud-based application programming interface (API) module 114, a page ranking module 116, an artificial intelligence (AI)-based processing assembly 118, and an implementation, tracking, and evaluation module (ITEM) 126.

The document filtering module 104 may be operationally coupled to the user device 102 and the document filtering module 104 configured to analyses and filter documents based on relevance to the received user inputs.

The intent recognition module 106 may be operationally coupled to the document filtering module 104 and the intent recognition module 106 configured to interpret the user inputs to identify the user's intent and specific requirements. The intent recognition module 106 may further comprise a conversational language understanding (CLU) engine 108, a knowledge-based database 110, and a plurality of domain-specific algorithm 112.

The cloud-based application programming interface (API) module 114 may be operationally coupled to the document filtering module 104 and the cloud-based application programming interface (API) module 114 configured to facilitate communication between the user device 102, the document filtering module 104, the intent recognition module 106, and external computing resources.

The page ranking module 116 may be operationally coupled to the cloud-based application programming interface (API) module 114 and the page ranking module 116 configured to rank filtered documents based on the relevance to the identified user intent and requirements.

The artificial intelligence (AI)-based processing assembly 118 may be operationally coupled to the cloud-based application programming interface (API) module 114 and the user device 102, and the artificial intelligence (AI)-based processing assembly 118 further having a document searching module 120, a text extraction module 122, and a summarizer 124.

The implementation, tracking, and evaluation module (ITEM) 126 may be integrated with the cloud-based application programming interface (API) module 114 and the implementation, tracking, and evaluation module (ITEM) 126 configured to enable the users to apply best practices in the school by providing recommendations for project management, tracking progress, and evaluating outcomes.

The documents may be analyzed and filtered by document filtering module 104 comprise school leadership standards, guidelines, and resources.

The artificial intelligence (AI)-based processing assembly 118 may also be integrated with a search and recommendation engine 130.

The conversational language understanding (CLU) engine 108 may analyses the user query via natural language processing techniques.

The natural language processing techniques may interpret the semantic meaning of user queries and extract key information required for generating the school improvement plan.

The knowledge-based database 110 may store domain-specific information and resources.

The domain-specific algorithms 112 may be configured to analyze and process user inputs based on the identified domain.

The document searching module 120 may retrieve relevant documents from internal and external sources.

The text extraction module 122 may extract key information and data from the retrieved documents.

The summarizer 124 may be an artificial intelligence driven module that generates concise summaries of the extracted information.

The user device 102 may be configured to allow the user to generate user queries, and receive user inputs related to school leadership strategies and improvement goals.

The implementation, tracking, and evaluation module (ITEM) 126 may be also configured to allow the user to input data related to school improvement projects and track the implementation progress, and monitor the progress of various school improvement initiatives and provides real-time updates to users.

The combined functioning of the implementation, tracking, and evaluation module (ITEM) 126 and the artificial intelligence (AI)-based processing assembly 118 may be operable to allow the user to access instructional and school leadership-related documents, and summarize the documents and inform about the relevant school leadership standards.

The implementation, tracking, and evaluation module (ITEM) 126 in combination with the artificial intelligence (AI)-based processing assembly 118 may evaluate the effectiveness of implemented strategies and integrates feedback for continuous improvement.

The system 100 may be include a chatbot 128 configured to answer the user queries related to school leadership strategies, improvement plans, and the use of the implementation, tracking, and evaluation module (ITEM) 126.

The chatbot 128 may also be operable to respond to the user queries with relevant information and resources, and guide the user through the process of creating, implementing, and tracking school improvement plans generated by the implementation, tracking, and evaluation module (ITEM) 126.

In an embodiment of the present disclosure, the user device 102 may be any electronic device, such as a smartphone, tablet, laptop, or desktop computer, that is utilized by an individual to interact with software applications, digital platforms, or online services. The user device 102 may be equipped with various input and output capabilities, including touchscreens, keyboards, microphones, and displays, enabling users to access and engage with content, perform tasks, and communicate with others. The user device 102 may act as the primary interface through which users connect to cloud-based services, access applications, and manage their activities.

In an embodiment of the present disclosure, the document filtering module 104 may employs advanced algorithms to analyze the content of documents, identifying key attributes such as relevance, topic, and alignment with specific criteria like school leadership standards. By applying these filters, the document filtering module 104 may effectively narrow down large volumes of data, ensuring that users are presented with only the most pertinent documents that meet specific needs. The document filtering module 104 may enhance the efficiency of information retrieval, allowing users to quickly access targeted content, improve decision-making, and reduce the time spent sifting through irrelevant materials.

In an embodiment of the present disclosure, the cloud-based application programming interface (API) module 114 may facilitate seamless integration and communication between various software applications and services within the system 100. The cloud-based application programming interface (API) module 114 enables external systems to access and interact with the system's 100 functionalities, such as data retrieval, content management, and user authentication, through standardized API calls. By leveraging cloud infrastructure. The cloud-based application programming interface (API) module 114 may ensure scalability, flexibility, and real-time accessibility, allowing developers to build and extend applications efficiently. The cloud-based application programming interface (API) module 114 may support secure data exchanges and enables the platform to integrate with third-party tools, enhancing its overall capabilities and ensuring a cohesive user experience across different services and environments. In a preferred embodiment, the cloud-based application programming interface (API) module 114 may incorporate the azure cognitive services.

In an embodiment of the present disclosure, the page ranking module 116 may utilize sophisticated algorithms to rank documents, articles, and other resources based on their alignment with predefined criteria, such as school leadership standards, user intent, and content quality. By analyzing various factors, including keyword relevance, content structure, and user engagement metrics, the page ranking module 116 may ensure that the most pertinent and valuable resources are prioritized and presented to users. The page ranking module 116 may enhance the overall user experience by delivering highly relevant information efficiently, supporting educators in making well-informed decisions.

In an embodiment of the present disclosure, the implementation, tracking, and evaluation module (ITEM) 126 is a proprietary project management tool designed to empower school leaders by providing a structured framework for applying best practices. The ITEM implementation, tracking, and evaluation module (ITEM) 126 enables users to systematically plan, monitor, and assess the progress of various initiatives, ensuring alignment with school leadership standards. In some embodiments, the implementation, tracking, and evaluation module (ITEM) 126 may have integrated features, such as real-time tracking and data-driven evaluations. The implementation, tracking, and evaluation module (ITEM) 126 may facilitate informed decision-making, fosters accountability, and supports continuous improvement efforts, ultimately driving positive outcomes in educational settings.

In an embodiment of the present disclosure, the conversational language understanding (CLU) engine 108 may be designed to comprehend and interpret natural language inputs from the users. The conversational language understanding (CLU) engine 108 may utilize advanced natural language processing (NLP) techniques to decipher the intent behind user queries, commands, or statements, enabling the system 100 to respond appropriately and contextually.

In an embodiment of the present disclosure, the knowledge-based database 110 may be a repository of structured and unstructured data that provides the contextual background needed to enhance the accuracy of intent recognition. The knowledge-based database 110 may include domain-specific knowledge, previous interactions, and predefined rules, which the system 100 can reference to better understand and respond to the user queries.

In an embodiment of the present disclosure, the domain-specific algorithms 112 may be specialized algorithms tailored to refine the intent recognition process by applying domain-specific logic and ensuring that the system 100 can handle a wide range of queries with high precision.

In an embodiment of the present disclosure, the document searching module 120 may locate relevant documents based on the user queries or predefined criteria. The document searching module 120 may use AI-driven search algorithms, this module scans through large datasets to identify documents that match specific keywords, topics, or other relevant parameters, ensuring that users receive accurate search results.

In an embodiment of the present disclosure, the text extraction module 122 may use AI techniques to identify and extract essential pieces of information, such as key phrases, data points, or sections of text that are most relevant to the user query. By isolating critical information, the text extraction module 122 may analyze and process large volumes of text. In an embodiment of the present disclosure, the summarizer 124 may leverage AI algorithms, and use the key insights from the documents to form a more comprehensible report, allowing users to quickly grasp the most important points. In a preferred embodiment, the artificial intelligence (AI)-based processing assembly 118 may incorporate azure open AI search.

FIG. 1B illustrates a functional block diagram for an artificial intelligence (AI)-powered computer-implemented system 100 for creating customized school improvement plans based on Microsoft Azure, in accordance with an embodiment of the present invention.

The FIG. 1B presents an exemplary workflow for the system 100, integrating several components to enhance user interactions and content processing. The system 100 receives a user input, where the user provides a query or document. This input undergoes document filtering to refine and organize the content. The filtered input is then processed through Azure Cognitive Services, a suite that enables advanced AI functions such as natural language understanding and machine learning. Thereafter, intent of the user input is identified via intent recognition combining functions such as, interpreting the user's intent and context, storing relevant data that supports intent recognition, and tailoring the AI's responses and recommendations to the specific needs of the domain in question.

Thereafter, page ranking is performed to organize and prioritize content based on relevance to the user's query. Simultaneously, the input is processed by Azure OpenAI Service, which includes document search for retrieving relevant documents from a vast repository, the text extraction to extract the most pertinent information from the retrieved documents, and summarizing to condense the extracted information into a concise and coherent summary. The summarized output is then presented back to the user, allowing for efficient review and decision-making. This workflow ensures that the users receive accurate, contextually relevant, and well-organized information in response to the user queries.

FIG. 1C illustrates a snapshot for the exemplary high-level technology stack for the artificial intelligence (AI)-powered computer-implemented system 100 for creating customized school improvement plans based on Microsoft Azure, in accordance with an embodiment of the present invention.

The FIG. 1C showcases simple architectural diagram showing the relationship between various components of the system 100. In an embodiment of the present disclosure, the client/front-end may be built using React.js. The server/back-end may use Node.js and MongoDB for handling server-side logic and database management, respectively. May other service may be integrated with the system including, Stripe for payment processing, QnA Bot as the chatbot 128 for answering the user queries, Cognitive Search for implementing search functionalities, and Azure Storage Blob for storing large amounts of unstructured data, such as images, videos, or logs.

In an embodiment of the present disclosure, the search and recommendation engine 130 may scan the available data and resources, leveraging the document searching module 120 to identify relevant documents and content. the search and recommendation engine 130 may analyse user behaviour, preferences, and historical interactions to suggest additional content, resources, or actions that align with the user's interests or goals.

In an embodiment of the present disclosure, the chatbot 128 integrated with the implementation, tracking, and evaluation module (ITEM) 126 may significantly enhance the user experience by providing real-time assistance, guidance, and automation. The chatbot 128 may act as an interactive, AI-driven interface that the users can engage with to access the ITEM's 126 features.

In an exemplary embodiment, the chatbot 128 may provide updates on the progress of specific initiatives, provide summaries of ongoing projects, aid in setting up new projects, tracking milestones, offer personal recommendations, suggest best practices, and/or generating summary reports. By responding to natural language queries and providing instant feedback, the chatbot 128 streamlines increase the accessibility of ITEM 128, allowing the users to manage more efficiently and effectively.

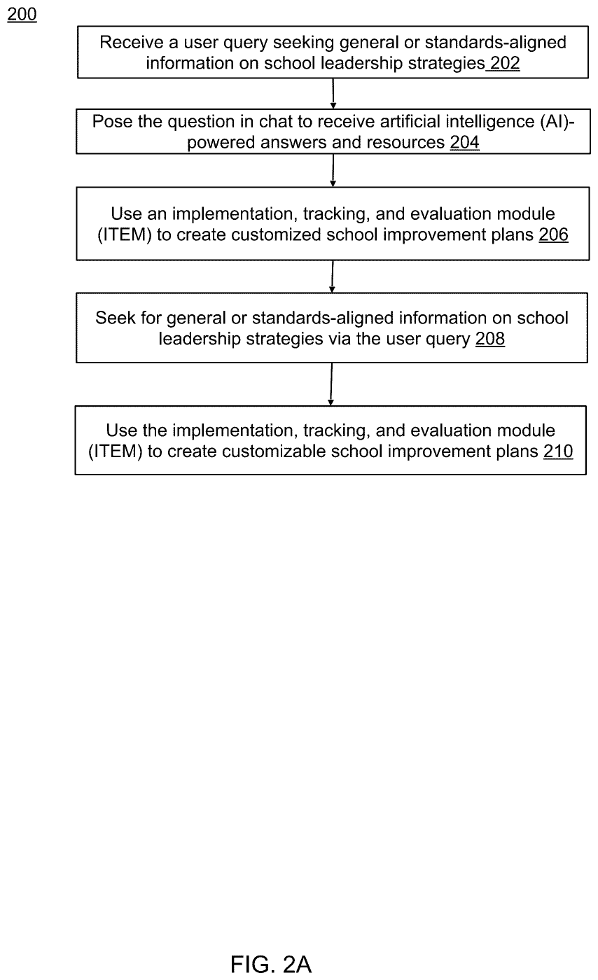

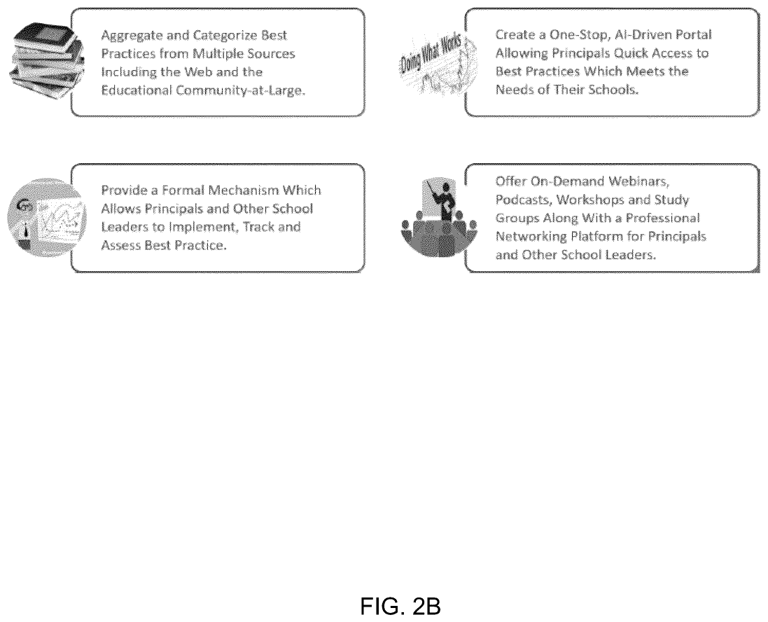

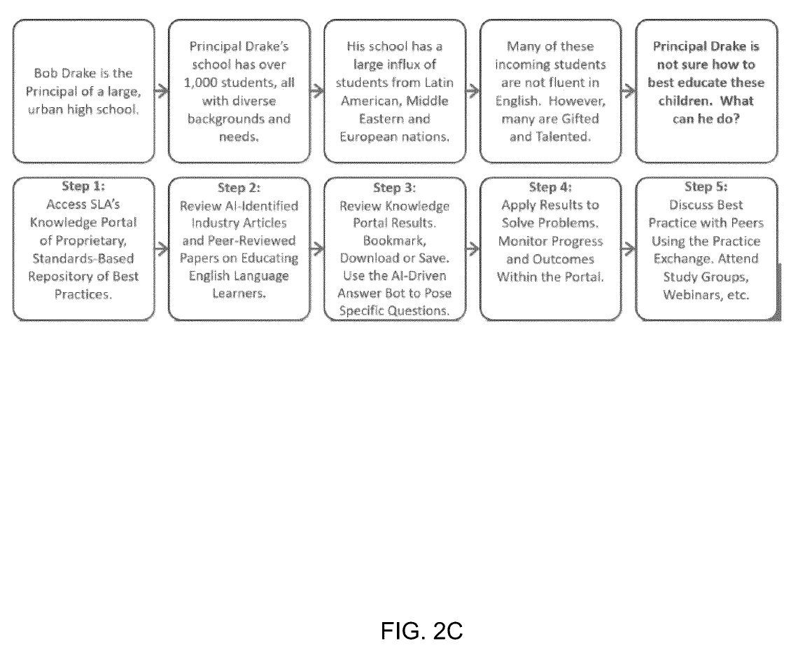

FIG. 2A illustrates a flowchart for a method 200 for creating customized school improvement plans using an artificial intelligence-powered platform, in accordance with an embodiment of the present invention.

The method 200 may comprise following steps.

At 202, receiving a user query seeking general or standards-aligned information on school leadership strategies.

At 204, posing the question in chat to receive artificial intelligence (AI)-powered answers and resources.

At 206, using an implementation, tracking, and evaluation module (ITEM) 126 to create customized school improvement plans.

At 208, seeking for general or standards-aligned information on school leadership strategies via the user query. The user query may be aimed at accessing and examining proprietary school leadership standards, state-specific school leadership standards and enter other school leadership standards for analysis.

At 210, using the implementation, tracking, and evaluation module (ITEM) 126 to create customizable school improvement plans.

In response to the user queries may be in the form of abstracts, related articles and links, and generated answers.

The method 200 may further comprise allowing the user to seek standards-aligned information on school leadership strategies. The method 200 may further comprise uploading school leadership documents by the user from the personal archives for analysis by the platform. The method 200 may further comprise summarizing the uploaded documents and presenting the summaries in full to the user for review. The method 200 may further comprise allowing the user to save or favorite the uploaded resources.

The method 200 may also include aligning the search and recommendation results obtained from a search and recommendation engine with the school leadership standards.

In an embodiment of the present disclosure, the method 200 gives preference to the standards-based search, which is only primary to the school improvement roadmap is important. In a preferred embodiment, a service level agreement (SLA) exists with platforms such as, but not limited to, ChatGPT and OpenAI.

FIG. 2B illustrates a snapshot for the overreaching function of the method 200 for creating customized school improvement plans using an artificial intelligence-powered platform, in accordance with an embodiment of the present invention;

In an embodiment of the present disclosure, the method 200 may aggregate and categorize best practices from multiple sources including the web and the educational community-at-large. In an embodiment of the present disclosure, the method 200 may create a one-stop, ai-driven portal allowing principals quick access to best practices which meets the needs of their schools.

In an embodiment of the present disclosure, the method 200 may provide a formal mechanism which allows principals and other school leaders to implement, track and assess best practice. In an embodiment of the present disclosure, the method 200 may offer on-demand webinars, podcasts, workshops and study groups along with a professional networking platform for principals and other school leaders.

FIG. 2C illustrates a snapshot for the exemplary use case of the method for creating customized school improvement plans using an artificial intelligence-powered platform, in accordance with an embodiment of the present invention

In an exemplary scenario, Bob Drake is the principal of a large, urban high school. Principal Drake's school has over 1,000 students, all with diverse backgrounds and needs. His school has a large influx of students from Latin American, Middle Eastern, and European nations. Many of these incoming students are not fluent in English. However, many are Gifted and Talented.

The method 200 may allow access SLA's knowledge portal of proprietary, standards-based repository of best practices. Thereafter, the method 200 may allow review of AI-identified industry articles and peer-reviewed papers on educating English language learners. Thereafter, the method 200 may allow to review knowledge portal results. bookmark, download, or save. use the ai-driven answer bot to pose specific questions. Thereafter, the method 200 may allow applying results to solve problems. monitor progress and outcomes within the portal. Thereafter, the method 200 may allow discussing best practice with peers using the practice exchange. attend study groups, webinars, and so.

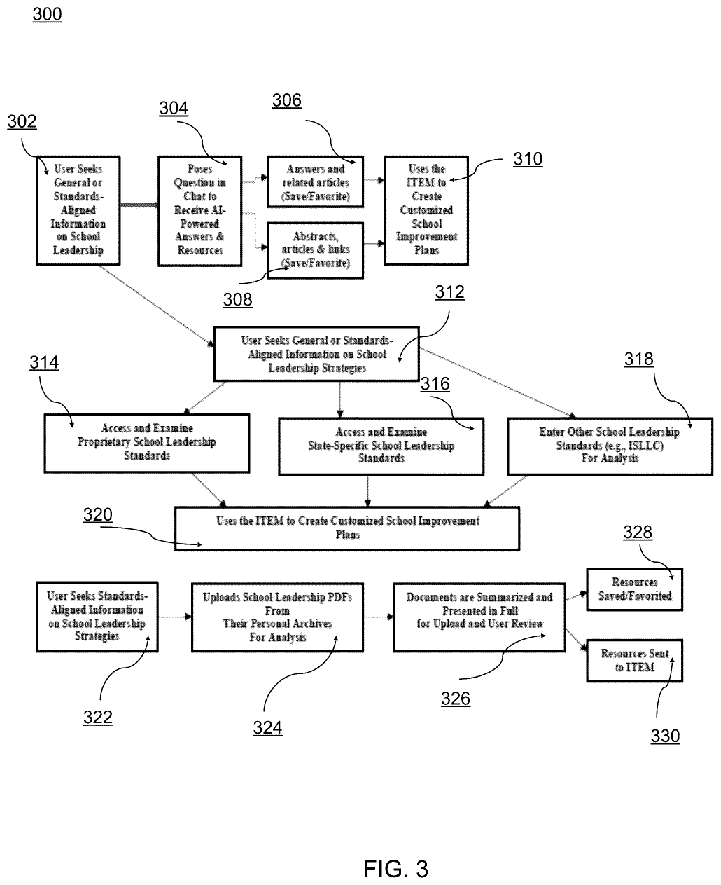

FIG. 3 illustrates an operational flowchart for a process 300 for educators seeking information and resources on school leadership, in accordance with an embodiment of the present invention.

In an embodiment of the present disclosure, the users can search for general or standards-aligned information, pose questions to receive AI-powered answers, and save or favorite relevant articles. They can access and analyze proprietary, state-specific, or other leadership standards (e.g., ISLLC) and use the information to create customized school improvement plans with the help of the Implementation, Tracking, and Evaluation Module (ITEM) 126. Additionally, users can upload their own school leadership documents for analysis, which are then summarized and reviewed, with resources saved and integrated into the ITEM 126. The process 300 may comprise the following steps.

At 302, user seeks general or standards-aligned information on school leadership.

At 304, poses question in chat to receive ai-powered answers and resources.

At 306, providing answers and related articles saved/favourited.

At 308, providing abstracts, articles & links (save/favourited).

At 310, use the item to create customized school improvement plans.

At 312, user seeks standards-aligned information on school leadership strategies.

At 314, access and examine proprietary school leadership standards.

At 316, access and examine state-specific school leadership standards.

At 318, enter other school leadership standards (e.g., ISLLC) for analysis.

At 320, use the ITEM 126 to create customized school improvement plans.

At 322, user seeks standards-aligned information on school leadership strategies.

At 324, upload school leadership PDFs from their personal archives for analysis.

At 326, documents are summarized and presented in full for upload and user review.

At 328, resources saved/favourite.

At 330, resources sent to the ITEM 126.

The disclosed invention offers many advantages. The disclosed invention provides the search results and recommendations that are highly relevant and tailored to the specific needs of school leaders. This ensures that the content and resources are directly applicable to their roles and responsibilities. The disclosed invention ensures consistency across the recommendations, making it easier for school leaders to implement best practices and align their efforts with recognized benchmarks.

The disclosed invention is a pioneering solution that provide recommendations that are based on the proven leadership principles. The data driven insights generated by the disclosed invention may guide school leaders in making informed decisions. This supports improves outcomes for schools and young student leaders. The disclosed invention provides real-time answers and references, enabling quick support and guidance when needed.

The implementation, tracking, and evaluation module (ITEM) 126 empowers school leaders and teachers to not only access resources but also apply them in actionable school improvement projects. By tracking the progress of initiatives and aligning them with standards, the implementation, tracking, and evaluation module (ITEM) 126 supports continuous improvement in school leadership practices.

The disclosed invention also simplifies workflow by providing AI assisted document summarization and user support in form of the chatbot, to make the implementation, tracking and management of leadership strategies more manageable.

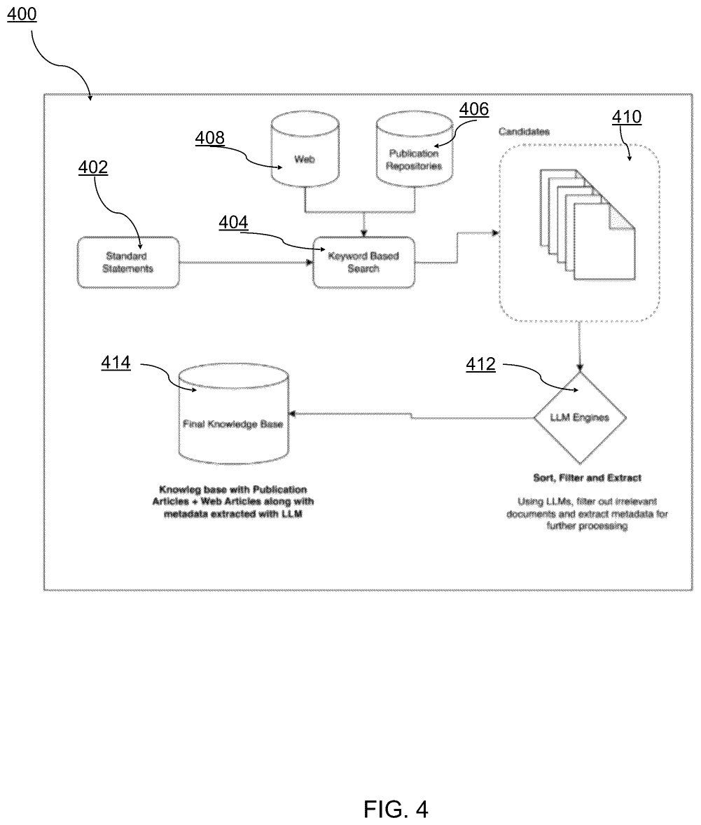

FIG. 4 illustrates an operational flowchart of knowledge base building process 400 for educators seeking information and resources on school leadership, in accordance with an embodiment of the present invention.

In an embodiment of the present disclosure, the process 400 may comprise following steps.

At 402, using “Standard Statements” for representing predefined search criteria or specific queries provided by the user.

At 404, initiating a keyword-based search.

At 406, searching the public repositories using the keyword-based search strategy.

At 408, searching the web using the keyword-based search strategy.

At 410, retrieving relevant documents or “candidates” from the web and publication repositories via the keyword-based search.

At 412, using large language model (LLM) engines for sorting, filtering, and extraction of data from the relevant documents.

At 414, forming final knowledge base as the structured repository where all the processed information is stored. The knowledge base contains the selected articles, documents, and web content, along with the metadata extracted using the LLM engines.

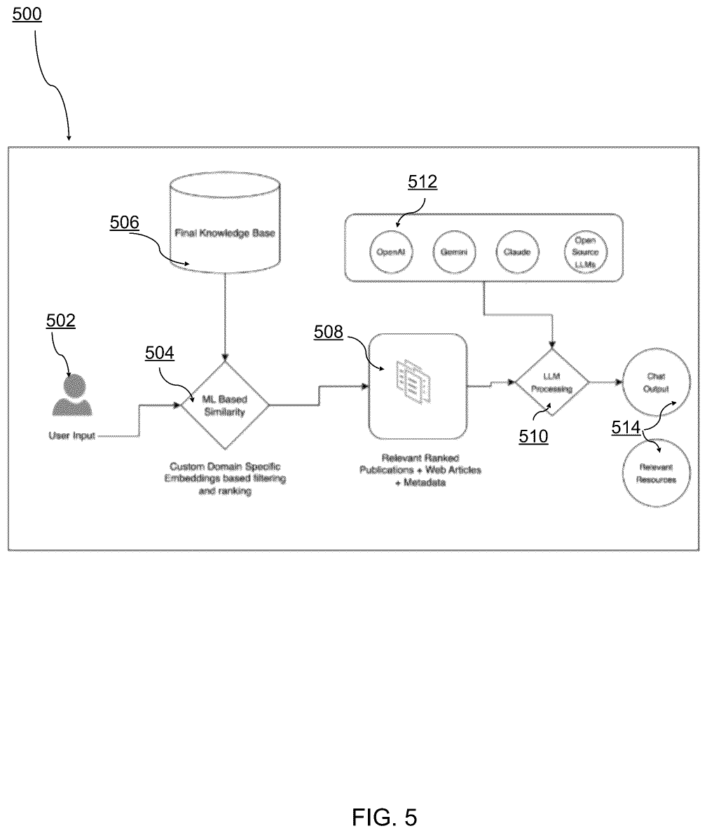

FIG. 5 illustrates an operational flowchart of a process 500 for user input processing for chat/resources, in accordance with an embodiment of the present invention.

In an embodiment of the present disclosure, the process 500 may comprise following steps.

At 502, receiving a user input.

At 504, performing machine learning (ML)-based similarity analysis for creating custom domain-specific embeddings based on filtering and ranking.

At 506, using the final knowledge base for finding documents or data within that closely match the user's input.

At 508, obtaining relevant ranked publications, web articles, and metadata that represents the output of the filtering and ranking based on ML-based similarity.

At 510, performing large language model (LLM) processing to further select and rank the documents.

At 512, utilizing various providers, such as OpenAI, Gemini, Claude, and open-source LLMs, to ensure a robust and comprehensive analysis.

At 514, providing chat output in terms chat responses and relevant resources.

In a case that no conflict occurs, the embodiments in the present disclosure and the features in the embodiments may be mutually combined. The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed for:

1. An artificial intelligence (AI)-powered computer-implemented system for connecting school leaders with informative resources that are aligned with industry-specific educational standards, the system comprising:
a user device;
a document filtering module operationally coupled to the user device, the document filtering module configured to analyse and filter documents based on relevance to the received user inputs;
an intent recognition module operationally coupled to the document filtering module, the intent recognition module configured to interpret the user inputs to identify the user's intent and specific requirements,
wherein the intent recognition module further comprises:
a conversational language understanding (CLU) engine;
a knowledge-based database; and
a plurality of domain-specific algorithms.
a cloud-based application programming interface (API) module operationally coupled to the document filtering module, the cloud-based application programming interface (API) module configured to facilitate communication between the user device, document filtering module, intent recognition module, and external computing resources;
a page ranking module operationally coupled to the cloud-based application programming interface (API) module, the page ranking module configured to rank filtered documents based on the relevance to the identified user intent and requirements;
an artificial intelligence (AI)-based processing assembly operationally coupled to the cloud-based application programming interface (API) module and the user device, the artificial intelligence (AI)-based processing assembly further having:
a document searching module;
a text extraction module;
a summarizer; and
an implementation, tracking, and evaluation module (ITEM) integrated with the cloud-based application programming interface (API) module, the implementation, tracking, and evaluation module (ITEM) configured to enable the users to apply best practices in the school by providing recommendations for project management, tracking progress, and evaluating outcomes.

2. The system of claim 1, wherein the documents analyzed and filtered by document filtering module comprise school leadership standards, guidelines, and resources.

3. The system of claim 1, wherein the artificial intelligence (AI)-based processing assembly is also integrated with a search and recommendation engine.

4. The system of claim 1, wherein the conversational language understanding engine analyses the user query via natural language processing techniques.

5. The system of claim 4, wherein the natural language processing techniques interpret the semantic meaning of user queries and extract key information required for generating the school improvement plan.

6. The system of claim 1, wherein the knowledge-based database storing domain-specific information and resources.

7. The system of claim 1, wherein the domain-specific algorithms are configured to analyze and process user inputs based on the identified domain.

8. The system of claim 1, wherein the document searching module retrieves relevant documents from internal and external sources.

9. The system of claim 1, wherein the text extraction module extracts key information and data from the retrieved documents.

10. The system of claim 1, wherein the summarizer is an artificial intelligence driven module that generates concise summaries of the extracted information.

11. The system of claim 1, wherein the user device is configured to:
allow the user to generate user queries; and
receiving user inputs related to school leadership strategies and improvement goals.

12. The system of claim 1, wherein the implementation, tracking, and evaluation module (ITEM) is also configured to:
allow the user to input data related to school improvement projects and track the implementation progress; and
monitor the progress of various school improvement initiatives and provides real-time updates to users.

13. The system of claim 12, wherein the combined functioning of the implementation, tracking, and evaluation module (ITEM) and the artificial intelligence (AI)-based processing assembly is operable to:
allow the user to access instructional and school leadership-related documents; and
summarize the documents and inform about the relevant school leadership standards.

14. The system of claim 13, wherein the implementation, tracking, and evaluation module (ITEM) in combination with the artificial intelligence (AI)-based processing assembly evaluate the effectiveness of implemented strategies and integrates feedback for continuous improvement.

15. The system of claim 12, wherein the system also includes a chatbot configured to answer the user queries related to school leadership strategies, improvement plans, and the use of the implementation, tracking, and evaluation module (ITEM).

16. The system of claim 15, wherein the chatbot is also operable to:
respond to the user queries with relevant information and resources; and
guide the user through the process of creating, implementing, and tracking school improvement plans generated by the implementation, tracking, and evaluation module (ITEM).

17. A method for creating customized school improvement plans using an artificial intelligence-powered platform, the method comprising:
receiving a user query seeking general or standards-aligned information on school leadership strategies;
posing the question in chat to receive artificial intelligence (AI)-powered answers and resources;
using an implementation, tracking, and evaluation module (ITEM) to create customized school improvement plans;
seeking for general or standards-aligned information on school leadership strategies via the user query,
wherein the user query is aimed at accessing and examining proprietary school leadership standards, state-specific school leadership standards and enter other school leadership standards for analysis; and
using the implementation, tracking, and evaluation module (ITEM) to create customizable school improvement plans.

18. The method of claim 17, wherein the user queries is in the form of abstracts, related articles and links, and generated answers.

19. The method of claim 17, wherein the method further comprises:
allowing the user to seek standards-aligned information on school leadership strategies;
uploading school leadership documents by the user from the personal archives for analysis by the platform;
summarizing the uploaded documents and presenting the summaries in full to the user for review; and
allowing the user to save or favourite the uploaded resources.

20. The method of claim 17, wherein the method also includes aligning the search and recommendation results obtained from a search and recommendation engine with the school leadership standards.
